(19) United States
(12) Patent Application Publication
(10) Pub. No.: US 2026/0064689 A1
(43) Pub. Date: Mar. 5, 2026

(54) SPECIAL HANDLING OF TASK SIZES FOR INTERPRETED CODE WITH HIGH OVERHEAD

(71) Applicant: SAP SE, Walldorf (DE)

(72) Inventors: Christina Teflioudi, Heidelberg (DE); Paul Willems, Heidelberg (DE); Marius Eich, Neustadt (DE)

(21) Appl. No.: 18/817,012

(22) Filed: Aug. 27, 2024

(51) Int. Cl. G06F 16/2453; G06F 11/34

(52) U.S. Cl. CPC G06F 16/24545; G06F 11/3409; G06F 16/24532; G06F 16/24549

(57) ABSTRACT

A database execution engine generates query execution plan for a received query, where the query execution plan includes one or more operators which will be interpreted by an interpreter when the query execution plan is executed. A query execution engine determines an overhead associated with preparation of the interpreter for executing the one or more operators of the query execution plan. Also, the query execution engine determines a preferred task size based on removing the overhead associated with preparation of the interpreter. During execution of the query execution plan, the query execution engine assigns tasks to one or more worker threads, where a task size of each assigned task is determined based on the preferred task size.

### TECHNICAL FIELD

The present disclosure generally relates to database management and, more specifically, to query execution on database tables.

### BACKGROUND

Database management systems have become an integral part of many computer systems. For example, some systems handle hundreds if not thousands of transactions per second. On the other hand, some systems perform very complex multidimensional analysis on data. In both cases, the underlying database may need to handle responses to queries very quickly in order to satisfy systems requirements with respect to transaction time. A database query is a mechanism for retrieving data from one or more database tables. Queries may be generated in accordance with a corresponding query language. For example, structured query language (SQL) is a declarative querying language that is used to retrieve data from a relational database. Given the complexity of queries and/or the volume of queries, the underlying databases face challenges when attempting to optimize performance.

### SUMMARY

In some implementations, a database execution engine generates query execution plan for a received query, where the query execution plan includes one or more operators which will be interpreted by an interpreter when the query execution plan is executed. A query execution engine determines an overhead associated with preparation of the interpreter for executing the one or more operators of the query execution plan. Also, the query execution engine determines a preferred task size based on removing the overhead associated with preparation of the interpreter. During execution of the query execution plan, the query execution engine assigns tasks to one or more worker threads, where a task size of each assigned task is determined based on the preferred task size.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of an example of a database system, in accordance with some example implementations of the current subject matter;

FIG. 2 illustrates a block diagram of a database execution engine, in accordance with some example implementations of the current subject matter;

FIG. 3 illustrates a block diagram of a query execution environment, in accordance with some example implementations of the current subject matter;

FIG. 4 illustrates a process for determining and assigning task sizes to worker threads implementing a query execution plan, in accordance with some example implementations of the current subject matter;

FIG. 5 illustrates a process for artificially reducing a cost per row metric, in accordance with some example implementations of the current subject matter;

FIG. 6 illustrates a process for employing different task sizes at parallelization points, in accordance with some example implementations of the current subject matter;

FIG. 7A depicts an example of a system, in accordance with some example implementations of the current subject matter; and

FIG. 7B depicts another example of a system, in accordance with some example implementations of the current subject matter.

### DETAILED DESCRIPTION

Database execution engines, apart from using the “precompiled” or “normal” C++ operators, also use code-generated operators using just-in-time compilation. Such operators can be executed directly by an interpreter (e.g. a Llang interpreter) with a usually slow execution, or they can be executed after a compilation step generates machine code which is much faster. In the second case however, a one-time overhead is needed for the compilation. Once the code is compiled, it may be stored in a cache where the same or other similar queries can reuse it. The second approach (compilation of interpreter code) makes sense for compute intensive queries which are executed often. On the other hand, for fast running queries which appear rarely, paying the price for the compilation might not make sense and thus direct execution using the interpreter might be a better option.

In some embodiments, a balanced approach may be employed to manage these aspects. In an example, the interpreter is used by default to execute the code up to a specific number of times. Then, the database execution engine will start an asynchronous job to compile the code while continuing to use the interpreter until the compiled code is ready. Once the compiled code is ready, the compiled code will be used from that point on. In this way fast queries can use the interpreter to compute results without having to wait for the compilation but also expensive queries will get to switch to the compiled code as soon as the compiled code is available. An exception is made in cases when the compilation is expected to take too long. This usually happens for extremely long programs. In such cases, the compilation of the code is not initiated, but rather the code is executed solely using the interpreter.

In an example, a database execution engine does not use a predefined number of workers and task size for all queries. Rather, a small sampling phase is implemented to decide whether to parallelize and how large the tasks should be. In the sampling phase, samples are cut from the beginning of the dataset and the elapsed time needed to execute the remaining pipeline is measured. If the elapsed time is relatively large, it is assumed that the query is compute intensive and relatively small-sized tasks are created. Otherwise, for cheaper queries, relatively larger task sizes are chosen. In an example, the following computation may be made: cost_per_row=elapsed_time_for_sample/sample_size.

In an example, the database execution engine has a target cost_per_task as a configuration parameter which describes in terms of time how long a task should be. Then, the size of the task may be calculated as: task_size=max(1, cost_per_task/cost_per_row). The underlying assumption is that the time required for a task to be executed mainly depends (in a linear way) on the number of rows that get processed (i.e., that there are no significant overheads per sample). Unfortunately, this is not true for code that gets executed by the interpreter. In more detail, for each call to the interpreter to process N rows (where N is a positive integer), the interpreter needs to perform some preparation once for all these N rows. The overhead of this preparation is not dependent on the number of rows. During sampling, the database execution engine cannot differentiate between one-time overhead and the time needed to process the rows. It observes only the overall time needed to process the whole sample. Thus, the database execution engine creates relatively small tasks and since the overhead is incurred per task, the runtime of the query suffers.

To mitigate these shortcomings, first, a measurement is taken of the overhead associated with the preparation. Then, the measurement of the overhead is propagated to the code responsible for the sampling and for making the task size decisions. This may be performed if it is known that the code executed will only be using the interpreter and will never get compiled. The overhead is then removed from the overall sampling measurement so that only the time that is actually needed for processing the rows is determined: elapsed_time_for_sample=elapsed_time_for_sample-overhead.

In addition, the database execution engine may control the overhead in terms of the percentage of the overall time for a task. Effectively, it may be advantageous to enlarge the target cost_per_task, in cases there is overhead, such that the new cost_per_task is multiple times the overhead. In an example, cost_per_task may be a configuration parameter applied to all scheduling points and therefore it may be desirable to effectively enlarge cost_per_task only for the specific cases that there is overhead due to interpretation. To accomplish this, instead of enlarging the cost_per_task in the previously presented equation, the cost_per_row metric may be artificially decreased. The computations may go as follows: cost_per_task_according_to_overhead=task_size_to_overhead_ratio*overhead, where task_size_to_overhead_ratio is a configuration parameter. Next computation: cost_per_task_to_use=max(cost_per_task, cost_per_task_according_to_overhead). Next computation: scaling_factor=cost_per_task/cost_per_task_to_use. Final computation: cost_per_row=scaling_factor*elapsed_time_for_sample/sample_size. With a task_size_to_overhead_ratio=10 (a default setting in one embodiment), a task size is calculated such that the overhead will be roughly 1/10 of the time of the whole task.

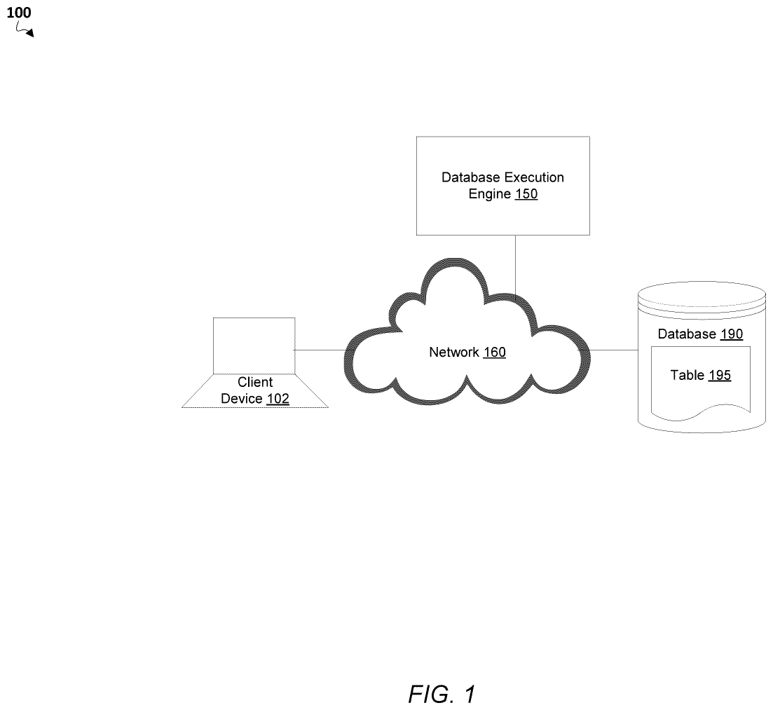

FIG. 1 depicts a system diagram illustrating an example of a database system 100, in accordance with some example embodiments. Referring to FIG. 1, the database system 100 may include one or more client devices 102, a database execution engine 150, and one or more databases 190. As shown in FIG. 1, the one or more client devices 102, the database execution engine 150, and the one or more databases 190 may be communicatively coupled via a network 160. The one or more databases 190 may include a variety of relational databases including, for example, an in-memory database, a column-based database, a row-based database, and/or the like. The database execution engine 150 may store a database table 195 at the one or more databases 190, with the database table 195 representative of any number and type of tables.

In some example embodiments, the one or more databases 190 may include a relational database. However, it should be appreciated that the one or more databases 190 may include any type of database including, for example, an in-memory database, a hierarchical database, an object database, an object-relational database, and/or the like. For example, instead of and/or in addition to including a relational database, the one or more databases 190 may include a graph database, a column store, a key-value store, a document store, and/or the like.

The one or more client devices 102 may include processor-based devices including, for example, a mobile device, a wearable apparatus, a personal computer, a workstation, an Internet-of-Things (IoT) appliance, and/or the like. The network 160 may be a wired network and/or wireless network including, for example, a public land mobile network (PLMN), a local area network (LAN), a virtual local area network (VLAN), a wide area network (WAN), the Internet, and/or the like.

To illustrate by way of an example, a given client device 102 may send a query via the database execution engine 150 to the database layer including the one or more databases 190, which may represent a persistence and/or storage layer where database tables may be stored and/or queried. Furthermore, the database execution engine 150 may provide the ability to access table storage via an abstract interface to a table adapter, which may reduce dependencies on specific types of storage and persistence layers, which may in turn enable use with different types of storage and persistence layers.

The database execution engine 150 may be configured to handle different types of databases and the corresponding persistent layers and/or tables therein. For example, the one or more databases 190 may include at least one row-oriented database, in which case an insert is performed by adding a row with a corresponding row identifier. Alternatively and/or additionally, the one or more databases 190 may include one or more column store databases, which may use dictionaries and compression techniques when inserting data into a table. Where the database layer includes multiple different types of databases, the database execution engine 150 may perform execution related to handling the differences between different types of databases such as row-oriented databases and column store databases. This may enable a reduction in processing at the database layer, for example, at each of the one or more databases 190. Moreover, the database execution engine 150 may perform other operations including rule-based operations, such as joins and projections, as well as filtering, group by, multidimensional analysis, and/or the like to reduce the processing burden on the database layer. In this way, the database execution engine 150 may execute these and other complex operations, while the one or more databases 190 can perform simpler operations to reduce the processing burden at the one or more databases 190.

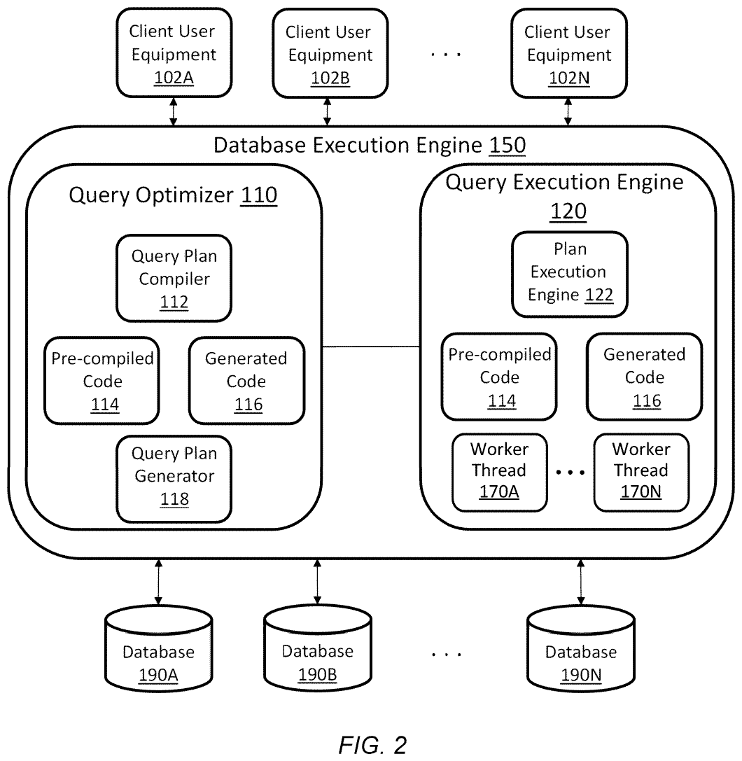

FIG. 2 depicts a block diagram illustrating an example of the database execution engine 150, in accordance with some example embodiments. As shown in FIG. 2, the one or more databases 190 may include a first database 190A, a second database 190B, a third database 190N, and so on. The one or more databases 190 can represent the database layer of a database management system (DBMS) where data may be persisted and/or stored in a structured way, and where the data may be queried or operated on using operations such as SQL commands or other types of commands/instructions to provide reads, writes, and/or perform other operations. To illustrate by way of an example, one or more client devices, which may include the client user equipment 102A-N, may send queries via the database execution engine 150 to the database layer including the one or more databases 190, which may represent a persistence and/or storage layer where database tables may be stored and/or queried. The queries may be sent via a connection, such as a wired connection and/or wireless connection (e.g., the Internet, cellular links, WiFi links, and/or the like) provided, for example, by the network 160.

In an example, the database execution engine 150 may include a query optimizer 110, such as a SQL optimizer and/or another type of optimizer, to receive at least one query from the one or more client devices 102 and generate a corresponding query plan (which may be optimized) for execution by a query execution engine 120. The query optimizer 110 may receive a request, such as a query, and then form or propose an optimized query plan. The query plan (which may be optimized) may be represented as a so-called “query algebra” or “relational algebra. ” The query plan may propose an optimum query plan with respect to, for example, the execution time of the overall query. To optimize a query, the query plan optimizer 110 may obtain one or more costs for the different ways the execution of the query plan may be performed, and the costs may be in terms of execution time at, for example, the one or more databases 190.

A query plan compiler 112 may enable compilation of at least a portion of the query plan. The query plan compiler 112 may compile the optimized query algebra into operations, such as program code and/or any other type of command, operation, object, or instruction. This code may include pre-compiled code 114 (which may be written in a high level language, pre-compiled, stored, and then selected for certain operations in the query plan) and/or dynamically generated code 116 including dynamically generated operators which can be executed directly by the use of an interpreter (slow execution) or compiled using a just-in-time (JIT) compiler and then executed (fast execution). The pre-compiled code 114 and the generated code 116 represent code for executing the query plan, and this code may be provided to a query plan generator 118, which interfaces with the query execution engine 120.

In some example embodiments, the query optimizer 110 may optimize the query plan by compiling and generating code. Moreover, the query optimizer 110 may choose a query execution engine that uses pipelining. The query execution engine 120 may receive, from the query plan generator 118, a plan containing operators in compiled code to enable execution of the optimized query plan, although the query execution engine 120 may also receive code or other commands directly from a higher-level application or another source such as the one or more client devices 102. The plan containing pre-compiled code 114 and/or the generated code 116 may be provided to a plan execution engine 122 of the query execution engine 120. The plan execution engine 122 may then prepare the plan for execution, and this query plan may include the pre-compiled code 114 and/or the generated code 116. When the code for the query plan is ready for execution during runtime, the query execution engine 120 may step through the code, performing some of the operations within the database execution engine 150 and sending some of the operations (or commands in support of an operation, such as a read, write, and/or the like) for execution at the one or more databases 190.

In some example embodiments, the query execution engine 120 may run, as noted above, the generated code 116 generated for some query operations, while the pre-compiled code 114 may be run for other operations. Moreover, the query execution engine 120 may combine the generated code 116 with the pre-compiled code 114 to further optimize execution of query related operations. In addition, the query execution engine 120 may provide for a plan execution framework that is able to handle data chunk(s), pipelining, and state management during query execution. Furthermore, the query execution engine 120 may provide the ability to access table storage via an abstract interface to a table adapter, which may reduce dependencies on specific types of storage/persistence layers (which may enable use with different types of storage/persistence layers).

To execute a query accessing a dataset, the query execution engine 120 may divide the query into a quantity of tasks. The task size used for dividing the query into tasks may be determined during a sampling phase based on the quantity of time required to execute the query on a predetermined sized portion of the dataset. Accordingly, if a large quantity of time is required to execute the query on the portion of the dataset, the query execution engine 120 may determine that the query is computationally intensive and thus divide the query into a relatively large quantity of smaller tasks. One or more of the worker threads 170 (e.g., a first worker thread 170A, a second worker thread 170N) may be allocated to perform the tasks associated with the query. The quantity of the worker threads 170 that the query execution engine 120 allocates may be determined based on the progress of the query observed at various time intervals. For example, upon allocating an initial quantity of the worker threads 170 to perform the tasks associated with the query, the database execution engine 150 may monitor the progress of the query (e.g., the quantity of tasks that have not been performed by any the worker threads 170, the quantity of tasks that have been performed relative to the total quantity of outstanding tasks, and/or the like) to determine whether to increase that initial quantity of the worker threads 170.

In some example embodiments, the database execution engine 150 may support a mixed execution model in which the sequence of operations include dynamically generated operations and precompiled operations. The precompiled operations may be associated with the precompiled code 114, which may include precompiled code written in a high level programming language that is inserted into a query plan during the generation of the query plan. Contrastingly, the dynamically generated operations may be associated with the generated code 116, which may be in a low-level assembly language. The dynamically generated operations may be executed directly with an interpreter or the dynamically generated operations may be compiled using a just-in-time (JIT) compiler and then executed.

In some example embodiments, the query execution engine 120 may use an interpreter to execute a dynamically generated operation (e.g., the generated code 116) up to a threshold quantity of times (e.g., three times) without compiling the corresponding code. After the dynamically generated operation has been executed the threshold quantity of times, the database execution engine 150 may initiate the compilation of the code associated with the dynamically generated operation to generate native code for the operation. For example, the code compilation may be performed as an asynchronous job, during which time the query execution engine 120 may continue to execute the dynamically generated operation using the interpreter. However, once the JIT-compiled code is ready, the query execution engine 120 may use the JIT-compiled code instead to execute the operation.

As noted, the query execution engine 120 may determine, during a sampling phase, whether to parallelize the processing of a query and the size of the individual tasks into which to divide the query. In some example embodiments, the database execution engine 150 may implement an adaptive parallel processing paradigm in order to support a mixed execution model that includes precompiled operations as well as dynamically generated operations. Instead of parallelizing a dynamically generated operation while the operation is still being performed using interpreted code, the query execution engine 120 may defer parallelizing the dynamically generated operation until JITcompiled code for the operation becomes available. For example, the query execution engine 120 may execute the dynamically generated operation sequentially for up to the threshold quantity of times. Thereafter, the query execution engine 120 may initiate an asynchronous job to compile the code associated with the dynamically generated operation such that the query execution engine 120 may continue to execute the dynamically generated operation while the corresponding code is being compiled. The compilation of the code associated with the dynamically generated operation may be prioritized in order to minimize any concomitant delays. For example, compilation jobs that are compiling the code may get priority over normal, data-processing jobs. Moreover, the query execution engine 120 may avoid monopolizing use of the relatively lower-priority worker threads 170 for executing the query plan but periodically return control to the database execution engine 150, to schedule the relatively higher-priority jobs for compiling the dynamically generated operations included in the query plan.

While the query execution engine 120 may continue to execute the dynamically generated operation sequentially during the compilation of the corresponding code, the query execution engine 120 may determine whether to parallelize and the size of the individual tasks once the JIT-compiled code for the dynamically generated operation becomes available. For example, during a sampling phase in which the query execution engine 120 executes the dynamically generated operation using an interpreter, the query execution engine 120 may determine the size of individual tasks based on removing the overhead associated with using the interpreter.

In some cases, the sequence of operations in the query plan may include a precompiled operation followed by a dynamically generated operation executed through the interpreter. Whereas multiple worker threads 170 may have been allocated to perform the precompiled operation in parallel, the database execution engine 150 may prevent the same quantity of worker threads from performing the dynamically generated operation. For example, the query execution engine 120 may permit a minimum quantity of the worker threads 170 to access the generated code 116 of the dynamically generated operation. Accordingly, while the first worker thread 170A is permitted to access the generated code 116 and perform the dynamically generated operation sequentially, other worker threads, such as the second worker thread 170N, may wait on a semaphore.

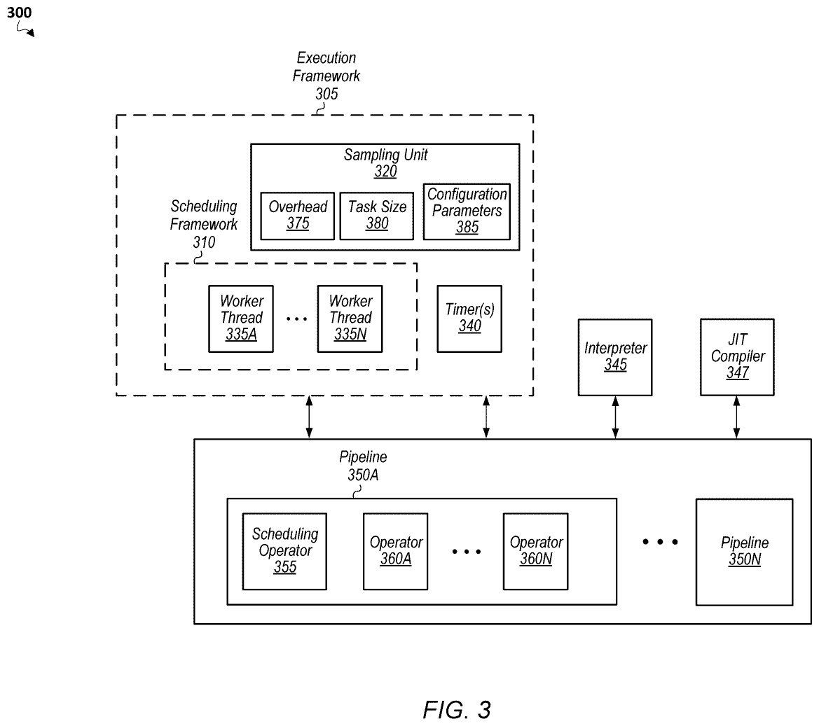

Referring now to FIG. 3, a block diagram of a query execution environment 300 is depicted, in accordance with one or more embodiments of the current subject matter. In an example, query execution environment 300 includes at least execution framework 305, interpreter 345, just-in-time (JIT) compiler 347, and pipelines 350A-N. Execution framework 305 may be implemented using any suitable combination of hardware (e.g., circuitry, one or more processing units) and/or software (e.g., program instructions). Execution framework 305 may include at least scheduling framework 310, sampling unit 320, and timer(s) 340. Scheduling framework 310 may create worker threads 335A-N which are representative of any number of worker threads. Worker threads 335A-N execute the operators (e.g., operators 360A-N) of the pipelines 350A-N on parts of data that form tasks. In an example, the work contained in the pipelines 350A-N is partitioned into tasks and the worker threads 335A-N repeatedly pick tasks and process them. It is noted that query execution environment 300 may also include other components which are not shown to avoid obscuring the figure.

When a query is received by a database execution engine (e.g., database execution engine 150 of FIG. 1), a query execution plan may be generated for the query. The query execution plan may include a plurality of query execution pipelines such as pipelines 350A-N, which are representative of any number and type of query execution pipelines. Each query execution pipeline in the plurality of query execution pipelines may be configured to execute a plurality of operations in a predetermined order associated with each query execution pipeline. Each pipeline 350A-N may include any number of operators, with scheduling operator 355 and operators 360A-N shown within pipeline 350A.

Execution framework 305 may be configured to determine various metrics and parameters associated with each received query. Execution framework 305 and/or scheduling operator 355 may also be configured to calculate a task size 380 based on these metrics/parameters associated with a received query. The task size 380 may then be utilized by scheduling framework 310 when scheduling worker threads 335A-N to perform tasks. In other words, the size of the task assigned to each worker thread 335A-N will be determined by the calculated task size 380.

As shown in FIG. 3, query execution environment 300 includes interpreter 345 and JIT compiler 347. For some queries, interpreter 345 and/or JIT compiler 347 may be utilized while for other queries, interpreter 345 and/or JIT compiler 347 may not be needed. Interpreter 345 may be configured to execute code-generated operators without first compiling the code-generated operators, while JIT compiler 347 may compile operators into native code. In an example, execution framework 305 is configured to calculate the value of overhead 375 based on the amount of overhead that is taken up by the use of interpreter 345. In some embodiments, scheduling operator 355 may initiate a sampling phase, choose a sample size, and execute the operators 360A-N after it in the pipeline 350A. After the sampling phase is initiated and while the pipeline operators are executed using the sample data, the sampling unit 320 uses timer(s) 340 to measure the time needed to execute various parts of the pipeline.

Timer(s) 340 may measure time in different parts of the plan. For example, timer(s) 340 may measure the overhead time of interpreted code, and timer(s) 340 may measure the time from one scheduling operator to the next scheduling operator or to the end of the pipeline (i.e., the time that would correspond to a sample or a task). In an example, the values used for the calculation of overhead 375 and the time measurement values are used during sampling and for determining the task size for the part of the pipeline after specific scheduling operator 355 and then are discarded afterwards.

Once sampling unit 320 has calculated overhead 375, scheduling operator 355 may then calculate task size 380 based on overhead 375 and various configuration parameters 385. Scheduling operator 355 and/or execution framework 305 may calculate task size 380 so that the use of interpreter 345 (i.e., the overhead) will be a relatively small percentage of the time of the whole task. Configuration parameters 385 may include a task_size_to_overhead_ratio parameter. In an example, the task_size_to_overhead_ratio parameter may be set to 10, which will result in the overhead (associated with interpreter 345) being about one tenth of the time of the whole task. In other examples, the task_size_to_overhead_ratio parameter may be set to other values.

Once scheduling operator 355 and/or execution framework 305 have calculated task size 380, scheduling framework 310 may utilize the value of task size 380 for partitioning the work contained in the pipelines 350A-N into tasks. In other words, the tasks that are performed by worker threads 335A-N will include a number of rows that are specified by task size 380. For example, if task size 380 is equal to 100 rows, each task assigned to worker threads 335A-N will have a task size of 100 rows.

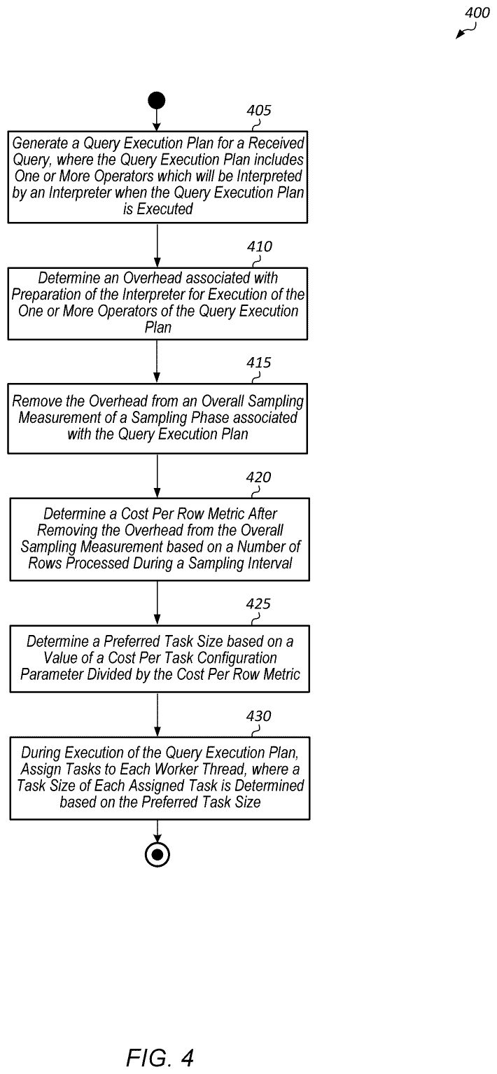

Turning now to FIG. 4, a process for determining and assigning task sizes to worker threads implementing a query execution plan is depicted, in accordance with one or more embodiments of the current subject matter. At the beginning of method 400, a database execution engine (e.g., database execution engine 150 of FIG. 1) generates a query execution plan for a received query, where the query execution plan includes one or more operators which will be interpreted by an interpreter when the query execution plan is executed (block 405). Next, the query execution engine determines an overhead associated with preparation of the interpreter for execution of the one or more operators of the query execution plan (block 410). In an example, the overhead is determined by calculating an amount of time needed for preparing the interpreter for execution of the one or more operators of the query execution plan. In other embodiments, the overhead determined by the query execution engine in block 410 may be associated with other factors besides the preparation of the interpreter. For example, the overhead may be associated with code that has a one-time overhead which might confuse sampling and cause small task sizes to be chosen. In these embodiments, the query execution engine determines the one-time overhead associated with the code in block 410.

Then, the query execution engine removes the overhead from an overall sampling measurement of a sampling phase associated with the query execution plan (block 415). Next, the query execution engine determines a cost per row metric after removing the overhead from the overall sampling measurement based on a number of rows processed during a sampling interval (block 420). Then, the query execution engine determines a preferred task size based on a value of a cost per task configuration parameter divided by the cost per row metric (block 425). Next, during execution of the query execution plan, the query execution engine assigns tasks to each worker thread, where a task size of each assigned task is determined based on the preferred task size (block 430). After block 430, method 400 may end.

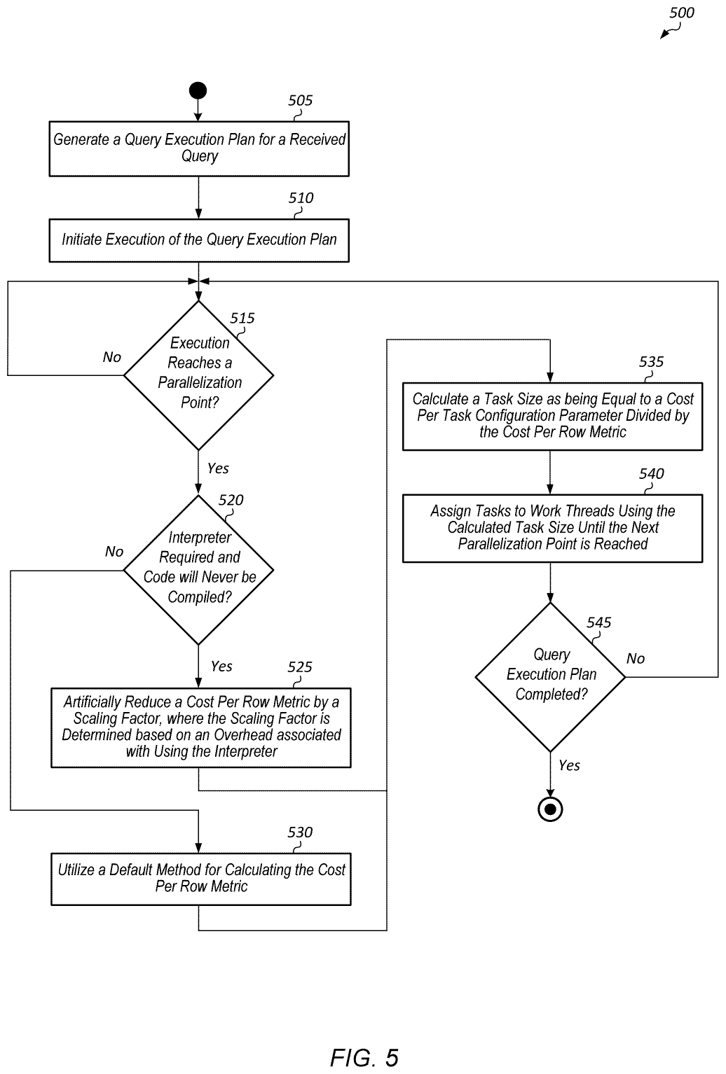

Referring now to FIG. 5, a process for artificially reducing a cost per row metric is depicted, in accordance with one or more embodiments of the current subject matter. A database execution engine (e.g., database execution engine 150 of FIG. 1) generates a query execution plan for a received query (block 505). Next, the database execution engine initiates execution of the query execution plan (block 510). When execution reaches a parallelization point (conditional block 515, “yes” leg), then the query execution engine determines if the parallelization point requires use of an interpreter (conditional block 520). If the query execution engine determines that the parallelization point requires the use of an interpreter and that the corresponding code will never be just-in-time compiled (conditional block 520, “yes” leg), then the database execution engine artificially reduces a cost per row metric by a scaling factor, where the scaling factor is determined based on an overhead associated with using the interpreter (block 525). If the query execution engine determines that the parallelization point does not require the use of an interpreter (conditional block 520, “no” leg), then the query execution engine utilizes the default method for calculating the cost per row metric (block 530). Next, the query execution engine calculates a task size as being equal to a cost per task configuration parameter divided by the cost per row metric (block 535). Then, the query execution engine assigns tasks to worker threads using the calculated task size until the next parallelization point is reached (block 540). If the query execution plan has been executed to completion (conditional block 545, “yes” leg), then method 500 ends. Otherwise, method 500 returns to block 515.

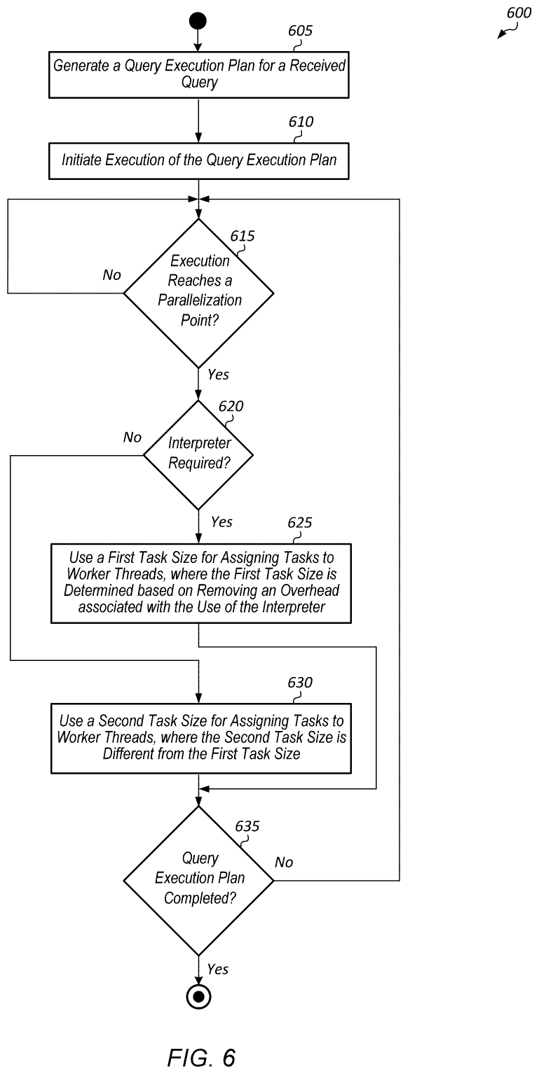

Turning now to FIG. 6, a process for employing different task sizes at parallelization points is depicted, in accordance with one or more embodiments of the current subject matter. A database execution engine (e.g., database execution engine 150 of FIG. 1) generates a query execution plan for a received query (block 605). Next, the database execution engine initiates execution of the query execution plan (block 610). When execution reaches a parallelization point (conditional block 615, “yes” leg), then the query execution engine determines if the parallelization point require use of an interpreter (conditional block 620). If the query execution engine determines that the parallelization point requires use of an interpreter (conditional block 620, “yes” leg), then the query execution engine uses a first task size for assigning tasks to worker threads, where the first task size is determined based on removing an overhead associated with the use of the interpreter (block 625). If the query execution engine determines that the parallelization point does not require use of the interpreter (conditional block 620, “no” leg), then the query execution engine uses a second task size for assigning tasks to worker threads, where the second task size is different from the first task size (block 630). If the query execution plan has been executed to completion (conditional block 635, “yes” leg), then method 600 ends. Otherwise, method 600 returns to block 615.

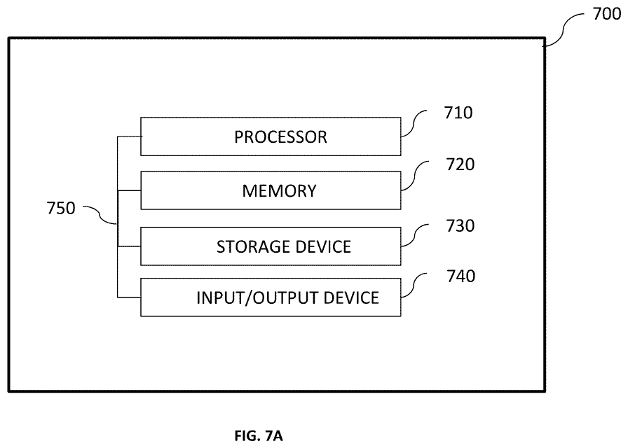

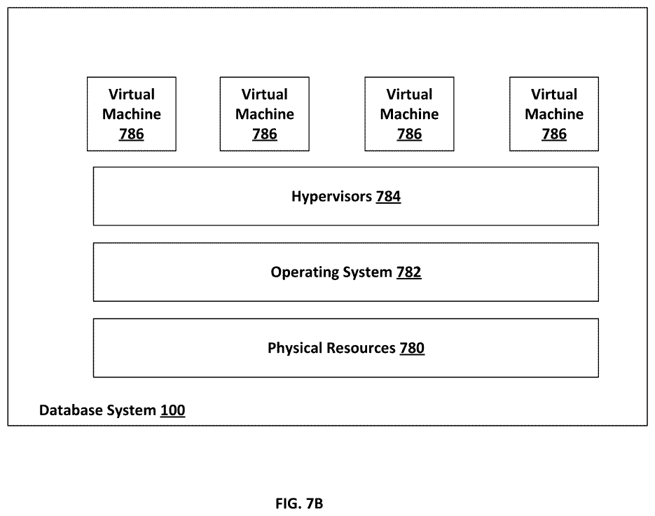

In some implementations, the current subject matter may be configured to be implemented in a system 700, as shown in FIG. 7A. The system 700 may include a processor 710, a memory 720, a storage device 730, and an input/output device 740. Each of the components 710, 720, 730 and 740 may be interconnected using a system bus 750. The processor 710 may be configured to process instructions for execution within the system 700. In some implementations, the processor 710 may be a single-threaded processor. In alternate implementations, the processor 710 may be a multi-threaded processor. The processor 710 may be further configured to process instructions stored in the memory 720 or on the storage device 730, including receiving or sending information through the input/output device 740. The memory 720 may store information within the system 700. In some implementations, the memory 720 may be a computer-readable medium. In alternate implementations, the memory 720 may be a volatile memory unit. In yet some implementations, the memory 720 may be a non-volatile memory unit. The storage device 730 may be capable of providing mass storage for the system 700. In some implementations, the storage device 730 may be a computer-readable medium. In alternate implementations, the storage device 730 may be a floppy disk device, a hard disk device, an optical disk device, a tape device, non-volatile solid state memory, or any other type of storage device. The input/output device 740 may be configured to provide input/output operations for the system 700. In some implementations, the input/output device 740 may include a keyboard and/or pointing device. In alternate implementations, the input/output device 740 may include a display unit for displaying graphical user interfaces.

FIG. 7B depicts an example implementation of the database system 100 (of FIG. 1). The database system 100 may be implemented using various physical resources 780, such as at least one or more hardware servers, at least one storage, at least one memory, at least one network interface, and the like. The database system 100 may also be implemented using infrastructure, as noted above, which may include at least one operating system 782 for the physical resources 780 and at least one hypervisor 784 (which may create and run at least one virtual machine 786). For example, each multitenant application may be run on a corresponding virtual machine 786.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising: generating a query execution plan for a received query, wherein the query execution plan comprises one or more operators which will be interpreted by an interpreter when the query execution plan is executed; determining an overhead associated with preparation of the interpreter for executing the one or more operators of the query execution plan; determining a preferred task size based on removing the overhead associated with preparation of the interpreter; and during execution of the query execution plan, assigning tasks to one or more worker threads, wherein a task size of each assigned task is determined based on the preferred task size.

Example 2: The computer-implemented method of Example 1, further comprising removing the overhead from an overall sampling measurement associated with the query execution plan.

Example 3: The computer-implemented method of any of Examples 1-2, further comprising determining the preferred task size based on removing the overhead from an overall sampling measurement associated with the query execution plan.

Example 4: The computer-implemented method of any of Examples 1-3, further comprising determining a cost per row metric based on a number of rows processed during a sampling interval after removing the overhead from the overall sampling measurement.

Example 5: The computer-implemented method of any of Examples 1-4, further comprising determining the preferred task size based on the cost per row metric.

Example 6: The computer-implemented method of any of Examples 1-5, further comprising determining the preferred task size based on a value of a cost per task configuration parameter divided by the cost per row metric.

Example 7: The computer-implemented method of any of Examples 1-6, wherein the preferred task size is determined such that the overhead is a given percentage of the preferred task size.

Example 8: The computer-implemented method of any of Examples 1-7, wherein the given percentage is in a range between 5% and 15%.

Example 9: The computer-implemented method of any of Examples 1-8, wherein the given percentage is applied only to parallelization points where the interpreter is being used and where code corresponding to the one or more operators will never get just-in-time compiled.

Example 10: The computer-implemented method of any of Examples 1-9, wherein the one or more operators will not be just-in-time compiled during execution of the query execution plan.

Example 11: A system comprising: at least one processor; and at least one memory storing instructions that, when executed by the at least one processor, cause operations comprising: generating a query execution plan for a received query, wherein the query execution plan comprises one or more operators which will be interpreted by an interpreter when the query execution plan is executed; determining an overhead associated with preparation of the interpreter for executing the one or more operators of the query execution plan; determining a preferred task size based on removing the overhead associated with preparation of the interpreter; and during execution of the query execution plan, assigning tasks to one or more worker threads, wherein a task size of each assigned task is determined based on the preferred task size.

Example 12: The system of Example 11, wherein the operations further comprise removing the overhead from an overall sampling measurement associated with the query execution plan.

Example 13: The system of any of Examples 11-12, wherein the operations further comprise determining the preferred task size based on removing the overhead from an overall sampling measurement associated with the query execution plan.

Example 14: The system of any of Examples 11-13, wherein the operations further comprise determining a cost per row metric based on a number of rows processed during a sampling interval after removing the overhead from the overall sampling measurement.

Example 15: The system of any of Examples 11-14, wherein the operations further comprise determining the preferred task size based on the cost per row metric.

Example 16: The system of any of Examples 11-15, wherein the operations further comprise determining the preferred task size based on a value of a cost per task configuration parameter divided by the cost per row metric.

Example 17: The system of any of Examples 11-16, wherein the preferred task size is determined such that the overhead is a given percentage of the preferred task size.

Example 18: The system of any of Examples 11-17, wherein the given percentage is in a range between 5% and 15%.

Example 19: The system of any of Examples 11-18, wherein the given percentage is applied only to parallelization points where the interpreter is being used and where code corresponding to the one or more operators will never get just-in-time compiled.

Example 20: A non-transitory computer readable medium storing instructions, which when executed by at least one data processor, result in operations comprising: generating a query execution plan for a received query, wherein the query execution plan comprises one or more operators which will be interpreted by an interpreter when the query execution plan is executed; determining an overhead associated with preparation of the interpreter for executing the one or more operators of the query execution plan; determining a preferred task size based on removing the overhead associated with preparation of the interpreter; and during execution of the query execution plan, assigning tasks to one or more worker threads, wherein a task size of each assigned task is determined based on the preferred task size.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
generating a query execution plan for a received query, wherein the query execution plan comprises one or more operators which will be interpreted by an interpreter when the query execution plan is executed;
determining an overhead associated with preparation of the interpreter for executing the one or more operators of the query execution plan;
determining a preferred task size based on removing the overhead associated with preparation of the interpreter; and
during execution of the query execution plan, assigning tasks to one or more worker threads, wherein a task size of each assigned task is determined based on the preferred task size.

2. The computer-implemented method of claim 1, further comprising removing the overhead from an overall sampling measurement associated with the query execution plan.

3. The computer-implemented method of claim 2, further comprising determining the preferred task size based on removing the overhead from the overall sampling measurement associated with the query execution plan.

4. The computer-implemented method of claim 2, further comprising determining a cost per row metric based on a number of rows processed during a sampling interval after removing the overhead from the overall sampling measurement.

5. The computer-implemented method of claim 4, further comprising determining the preferred task size based on the cost per row metric.

6. The computer-implemented method of claim 4, further comprising determining the preferred task size based on a value of a cost per task configuration parameter divided by the cost per row metric.

7. The computer-implemented method of claim 6, wherein the preferred task size is determined such that the overhead is a given percentage of the preferred task size.

8. The computer-implemented method of claim 7, wherein the given percentage is in a range between 5% and 15%.

9. The computer-implemented method of claim 7, wherein the given percentage is applied only to parallelization points where the interpreter is being used and where code corresponding to the one or more operators will never get just-in-time compiled.

10. The computer-implemented method of claim 1, wherein the one or more operators will not be just-in-time compiled during execution of the query execution plan.

11. A system comprising:
at least one processor; and
at least one memory storing instructions that, when executed by the at least one processor, cause operations comprising:
generating a query execution plan for a received query, wherein the query execution plan comprises one or more operators which will be interpreted by an interpreter when the query execution plan is executed;
determining an overhead associated with preparation of the interpreter for executing the one or more operators of the query execution plan;
determining a preferred task size based on removing the overhead associated with preparation of the interpreter; and
during execution of the query execution plan, assigning tasks to one or more worker threads, wherein a task size of each assigned task is determined based on the preferred task size.

12. The system of claim 11, wherein the operations further comprise removing the overhead from an overall sampling measurement associated with the query execution plan.

13. The system of claim 12, wherein the operations further comprise determining the preferred task size based on removing the overhead from the overall sampling measurement associated with the query execution plan.

14. The system of claim 12, wherein the operations further comprise determining a cost per row metric based on a number of rows processed during a sampling interval after removing the overhead from the overall sampling measurement.

15. The system of claim 14, wherein the operations further comprise determining the preferred task size based on the cost per row metric.

16. The system of claim 14, wherein the operations further comprise determining the preferred task size based on a value of a cost per task configuration parameter divided by the cost per row metric.

17. The system of claim 16, wherein the preferred task size is determined such that the overhead is a given percentage of the preferred task size.

18. The system of claim 17, wherein the given percentage is in a range between 5% and 15%.

19. The system of claim 17, wherein the given percentage is applied only to parallelization points where the interpreter is being used and where code corresponding to the one or more operators will never get just-in-time compiled.

20. A non-transitory computer readable medium storing instructions, which when executed by at least one data processor, result in operations comprising:
generating a query execution plan for a received query, wherein the query execution plan comprises one or more operators which will be interpreted by an interpreter when the query execution plan is executed;
determining an overhead associated with preparation of the interpreter for executing the one or more operators of the query execution plan;
determining a preferred task size based on removing the overhead associated with preparation of the interpreter; and
during execution of the query execution plan, assigning tasks to one or more worker threads, wherein a task size of each assigned task is determined based on the preferred task size.
